(19) United States
(12) Patent Application Publication
(10) Pub. No.: US 2022/0275233 A1
(43) Pub. Date: Sep. 1, 2022

(54) Ink Jet Ink Composition And Recording Method

(71) Applicant: Seiko Epson Corporation, Tokyo (JP)

(72) Inventors: Kiyomi KUMAMOTO, Kitakyushu (JP); Tomohito NAKANO, Shiojiri (JP); Tomoki MARUYAMA, Matsumoto (JP); Manabu TANIGUCHI, Shiojiri (JP)

(21) Appl. No.: 17/680,394

(22) Filed: Feb. 25, 2022

(30) Foreign Application Priority Data
Feb. 26, 2021 (JP) 2021-030637

(51) Int. Cl. C09D 11/328; C09D 11/033; B41M 5/00

(52) U.S. Cl. CPC C09D 11/328; C09D 11/033; B41M 5/0023

(57) ABSTRACT

An ink jet ink composition of the present disclosure includes a coloring material, water, an acetylene glycol-based surfactant having a HLB value of 4 or less, and 1-(2-hydroxyethyl)-2-pyrrolidone. The content of 1-(2-hydroxyethyl)-2-pyrrolidone in the ink jet ink composition is 0.5% by mass or more and 5.0% by mass or less.

The present application is based on, and claims priority from JP Application Serial Number 2021-030637, filed Feb. 26, 2021, the disclosure of which is hereby incorporated by reference herein in its entirety.

### BACKGROUND

### 1. Technical Field

The present disclosure relates to an ink jet ink composition and a recording method.

### 2. Related Art

The use of ink jet printing has recently been expanded, and applications thereof include, besides an office/home printer, commercial printing, textile printing, and the like.

An ink for ink jet is required to have excellent ejection stability by an ink jet method in order to form a desired pattern.

In addition, an ink composition using an acetylene glycol-based surfactant having a HLB value of 4 or less is used for the purpose of enhancing a defoaming property and adjusting surface tension and wettability (refer to, for example, JP-A-2019-19306).

However, the inventor of the present disclosure found that an ink composition containing an acetylene glycol-based surfactant having a HLB value of 4 or less has the following problem. That is, the inventor found that defoaming property can be enhanced, and surface tension and wettability can be adjusted, but the components of the ink composition are easily separated by heating or the like due to having a relatively low cloud point. Thus, there are caused the problems such as an increase in attacking property of the ink composition to the member of a flow passage, a change in hue, and a change in ejection behavior by an ink jet method due to a change in physical properties of the ink composition. That is, there is a problem in producing a stable ink composition without causing turbidity even at high temperature while having the good defoaming property.

### SUMMARY

The present disclosure has been achieved for solving the problems described above and can be realized as the following aspects.

According to an aspect of the present disclosure, an ink jet ink composition includes a coloring material, water, an acetylene glycol-based surfactant having a HLB value of 4 or less, and 1-(2-hydroxyethyl)-2-pyrrolidone.

In the ink jet ink composition according to the aspect of the disclosure, the content of the acetylene glycol-based surfactant in the ink jet ink composition may be 0.05% by mass or more and 1.0% by mass or less.

In the ink jet ink composition according to the aspect of the disclosure, the content of 1-(2-hydroxyethyl)-2-pyrrolidone in the ink jet ink composition may be 0.5% by mass or more and 5.0% by mass or less.

The ink jet ink composition according to the aspect of the disclosure may further include a surfactant having a HLB value of 10 or more.

The ink jet ink composition according to the aspect of the disclosure may further include trimethyl glycine at a content of 5.0% by mass or less.

In the ink jet ink composition according to the aspect of the disclosure, the coloring material may be a dye.

In the ink jet ink composition according to the aspect of the disclosure, the content of the coloring material in the ink jet ink composition may be 1.0% by mass or more and 5.5% by mass or less.

In the ink jet ink composition according to the aspect of the disclosure, when the content of the acetylene glycol-based surfactant in the ink jet ink composition is XA [% by mass], and the content of the 1-(2-hydroxyethyl)-2-pyrrolidone in the ink jet ink composition is XB [% by mass], a relation of the following formula (1) is satisfied.

5≤XB/XA≤100 (1)

According to an aspect of the present disclosure, a recording method includes ejecting and adhering the ink jet ink composition according to the aspect of the disclosure to a recording medium by an ink jet method.

### DESCRIPTION OF EXEMPLARY EMBODIMENTS

An Embodiment of the present disclosure is described in detail below.

### 1. Ink Jet Ink Composition

First, an ink jet ink composition of the present disclosure is described.

The ink jet ink composition of the present disclosure contains a coloring material, water, an acetylene glycol-based surfactant having a HLB value of 4 or less, and 1-(2-hydroxyethyl)-2-pyrrolidone.

Therefore, excellent defoaming property can be exhibited, surface tension and wettability can be preferably adjusted, and the stability of the ink jet ink composition can be improved, thereby enabling to effectively prevent the occurrence of problems described below. That is, for example, even when exposed to a high-temperature environment and stored for a long period, the constituent components of the ink jet ink composition are hardly separated, thereby enabling to effectively prevent the occurrence of problems such as an increase in attacking property of the ink jet ink composition to the member of a flow passage, a change in hue, and a change in ejection behavior by an ink jet method due to a change in physical properties of the ink jet ink composition. In addition, the moisture retention property of the ink jet ink composition is improved, and thus the solid content of the ink jet ink composition is effectively prevented from being unwillingly precipitated by drying in an ink jet head or the like. Therefore, clogging recoverability can be improved, and the ejection stability of the ink jet ink composition can be improved.

### 1-1 Coloring Material

The ink jet ink composition of the present disclosure contains the coloring material. Examples of the coloring material include various pigments, dyes, and the like.

In particular, when the coloring material contained in the ink jet ink composition is a dye, high color development can be obtained on a paper surface, and particularly the effect of easily obtaining high color development can be achieved with exclusive paper.

In general, a black ink, particularly a black dye ink, contains a plurality types of coloring materials, and the problems described above easily occur due to a high total content of the coloring materials. However, even with such an ink, the present disclosure can effectively prevent the occurrence of the problems described above. That is, when the ink jet ink composition is applied to a black ink, the effect of the present disclosure is remarkably exhibited.

The content of the coloring material in the ink jet ink composition is not particularly limited but is, for example, preferably 1.0% by mass or more and 5.5% by mass or less and more preferably 1.5% by mass or more and 5.3% by mass or less.

Thus, a satisfactory color density can be easily secured in a recording portion formed by using the ink jet ink composition, and high-temperature stability, storage stability, ejection stability clogging recoverability, etc. of the ink jet ink composition can be more improved.

### 1-2 Water

The ink jet ink composition of the present disclosure contains water. For example, in the ink jet ink composition, water is a component functioning as a solvent that dissolves the coloring material or a dispersion medium that disperses the coloring material.

In addition, when the ink jet ink composition contains water, the surfactant and 1-(2-hydroxyethyl)-2-pyrrolidone can be uniformly contained in the ink jet ink composition, and the functions thereof can be effectively exhibited.

The content of water in the ink jet ink composition of the present disclosure is preferably 85.0% by mass or more and 99.0% by mass or less, more preferably 87.0% by mass or more and 97.0% by mass or less, and still more preferably 88.0% by mass or more and 94.0% by mass or less.

Thus, the viscosity of the ink jet ink composition can be more securely adjusted to a preferred value, and ejection stability by the ink jet method can be more improved.

### 1-3 Acetylene Glycol-Based Surfactant Having HLB Value of 4 or Less

The ink jet ink composition of the present disclosure contains the acetylene glycol-based surfactant having a HLB value of 4 or less.

When the acetylene glycol-based surfactant having a HLB value of 4 or less is contained, the defoaming property of the ink jet ink composition can be improved, and surface tension and wettability can be preferably adjusted.

Examples of the acetylene glycol-based surfactant having a HLB value of 4 or less include Surfynol MD-20 (HLB 4), Surfynol 82 (HLB 4), Surfynol DF110D (HLB 3, 2,5,8,11-tetramethyl-6-dodecyne-5,8-diol), other Olfine 104 series and Olfine E1010 E series (the above manufactured by Nissin Chemical Industry Co., Ltd.), Olfine EXP4300 (carbon number 12-ethylene oxide adduct), Surfynol 61, Surfynol 465, Surfynol 104S (HLB 4), Surfynol 104PG50 (HLB 4, 2,4,7,9-tetramethyl-5-decyne-4,7-diol), and Surfynol 420 (HLB 4) (product names, manufactured by Air Products Japan Inc.), and the like. One or combination of two or more selected from these can be used.

The content of the acetylene glycol-based surfactant having a HLB value of 4 or less in the ink jet ink composition is preferably 0.05% by mass or more and 1.0% by mass or less, more preferably 0.06% by mass or more and 0.70% by mass or less, and still more preferably 0.07% by mass or more and 0.40% by mass or less.

Thus, the effect obtained by containing the acetylene glycol-based surfactant having a HLB value of 4 or less as described above can be significantly exhibited, and solubility in the ink jet ink composition can be more improved.

### 1-4 1-(2-Hydroxyethyl)-2-Pyrrolidone

The ink jet ink composition or the present disclosure contains 1-(2-hydroxyethyl)-2-pyrrolidone.

Therefore, even when the acetylene glycol-based surfactant having a HLB value of 4 or less as described above is contained, stability of the ink jet ink composition is improved. Consequently, for example, even when exposed to a high-temperature environment or when stored for a long period of time, the constituent components of the ink jet ink composition are hardly separated, thereby enabling to effectively prevent the occurrence of the problems such as an increase in attacking property of the ink jet ink composition to the member of a flow passage, a change in hue, and a change in ejection behavior by the ink jet method due to a change in physical properties of the ink composition. In addition, the moisture retention property of the ink jet ink composition is improved, and thus the solid content in the ink jet ink composition can be effectively prevented from being unwillingly precipitated or the like due to drying or the like in the ink jet head. This can cause excellent clogging recoverability and excellent ejection stability of the ink jet ink composition.

The content of 1-(2-hydroxyethyl)-2-pyrrolidone in the ink jet ink composition is preferably 0.5% by mass or more and 5.0% by mass or less, more preferably 0.8% by mass or more and 4.5% by mass or less, and still more preferably 1.0% by mass or more and 4.0% by mass or less.

Thus, the effect obtained by containing 1-(2-hydroxyethyl)-2-pyrrolidone as described above can be significantly exhibited, and the odor and coloring caused by 1-(2-hydroxyethyl)-2-pyrrolidone can be effectively suppressed.

When the content of the acetylene glycol-based surfactant having a HLB value of 4 or less in the ink jet ink composition is XA [% by mass], and the content of 1-(2-hydroxyethyl)-2-pyrrolidone in the ink jet ink composition is XB [% by mass], the following relation is preferably satisfied. That is, the relation 5≤XB/XA≤100 is preferably satisfied, the relation 10≤XB/XA≤80 is more preferably satisfied, and the relation 15≤XB/XA≤60 is still more preferably satisfied.

This improves the solubility of acetylene glycol in an ink state at high temperature and moisture retention reliability (evaluation of clogging recoverability in examples) in a nozzle surface.

### 1-5 Surfactant Having HLB Value of 10 or More

The ink jet ink composition may further contain a surfactant having a HLB value of 10 or more in addition to the coloring material, water, the acetylene glycol-based surfactant having a HLB value of 4 or less, and 1-(2-hydroxyethyl)-2-pyrrolidone described above.

This more improves the defoaming property, initial filling property, and wettability of the ink jet ink composition.

Examples of the surfactant having a HLB value of 10 or more include Olfine E1010, Olfine EXP4300, Olfine E1030W, and Silface SAG503A (manufactured by Nissin Chemical Industry Co., Ltd.), and the like. These can be used singly or in combination of two or more selected therefrom.

The content of the surfactant having a HLB value of 10 or more in the ink jet ink composition is preferably 0.05% by mass or more and 1.0% by mass or less, more preferably 0.10% by mass or more and 0.80% by mass or less, and still more preferably 0.20% by mass or more and 0.70% by mass or less. Thus, the effect described above is more significantly exhibited.

### 1-6 Trimethyl Glycine

The ink jet ink composition may further contain trimethyl glycine in addition to the coloring material, water, the acetylene glycol-based surfactant having a HLB value of 4 or less, and 1-(2-hydroxyethyl)-2-pyrrolidone described above.

This can more improve the defoaming property and clogging recoverability of the ink jet ink composition.

The content of trimethyl glycine in the ink jet ink composition is preferably 5.0% by mass or less, more preferably 4.5% by mass or less, and still more preferably 0.3% by mass or more and 4.0% by mass or less. Thus, the effect described above is more significantly exhibited.

### 1-7 Other Component

The ink jet ink composition of the present disclosure may contain a component other than the components described above. Such a component is also referred to as the “other component”.

Examples of the other component include a chelating agent, a preservative agent, an anti-mold agent, an anti-rust agent, a flame retardant, various dispersants, a water-soluble organic solvent other than 1-(2-hydroxyethyl)-2-pyrrolidone and trimethyl glycine, a surfactant other than the above, an antioxidant; an ultraviolet absorber, an oxygen absorber; a solubilizer, a penetrant, and the like.

Examples of the chelating agent include ethylenediamine tetraacetate salts and the like. Examples of the preservative/anti-mold agent include sodium benzoate, pentachlorophenol sodium, 2-pyridinethiol-1-oxide sodium, sodium sorbate, sodium dehydroacetate, 1,2-dibenzoisothiazolin-3-one, 4-chloro-3-methylphenol, and the like. Examples of the anti-rust agent include benzotriazole and the like.

For example, a compound having an isothiazoline ring structure in its molecule can be preferably used as a preservative/anti-mold agent.

Usable examples of the surfactant include various surfactants such as an anionic surfactant, a cationic surfactant, a nonionic surfactant, and the like.

The content of the other component is preferably 6.0% by mass or less and more preferably 5.0% by mass or less. The lower limit of the content of the other component is 0% by mass.

### 1-8 Other

The surface tension at 25° C. of the ink jet ink composition of the present disclosure is not particularly limited, but is preferably 20 mN/m or more and 60 mN/m or less, more preferably 25 mN/m or more and 50 mN/m or less, and still more preferably 30 mN/m or more and 40 mN/m or less.

Thus, nozzle clogging or the like of an ink jet head more hardly occurs, and ejection stability of the ink jet ink composition is more improved. In addition, even when nozzle clogging occurs, recoverability can be more improved by capping the nozzles.

In addition, a value measured by a Wilhelmy method or a ring method can be used as surface tension. The surface tension can be measured by using a surface tensiometer (for example, DY-300, DY-500, DY-700, or the like manufactured by Kyowa Interface Science Co., Ltd.).

The viscosity at 25° C. of the ink jet ink composition of the present disclosure is preferably 2 mPa·s or more and 10 mPa·s or less and more preferably 3 mPa·s or more and 8 mPa·s or less.

This more improves the ejection stability by the ink jet method for the ink jet ink composition.

The viscosity can be determined by measurement using a vibration-type viscometer, a rotation-type viscometer, a capillary-type viscometer, or a falling ball-type viscometer. For example, the viscosity can be determined by measurement using a vibration-type viscometer according to JIS 28809.

The ink jet ink composition of the present disclosure may be ejected by the ink jet method, and examples of the ink jet method include a charge defection system, a continuous system, a piezo system, an on-demand system such as a bubble jet (registered trade name) system, and the like. In particular, the ink jet ink composition of the present disclosure is preferably ejected by an ink jet head using a piezo vibrator.

Therefore, denaturation of the coloring material in the ink jet head can be more effectively prevented, and ejection stability by the ink jet method can be more improved.

Also, the ink jet ink composition of the present disclosure is ejected by the ink jet method, but the ink jet ink composition is not limited to be ejected directly to the final recording medium and may be once ejected to an intermediate transfer medium and then ejected to the final recording medium.

In particular, the ink jet ink composition of the present disclosure may be once ejected to an intermediate transfer medium and then transferred to a fabric as the recording medium by sublimation, that is, may be used for sublimation transfer textile printing.

### 2. Ink Jet Ink Composition Set

Next, an ink jet ink composition set according to the present disclosure is described.

The ink jet ink composition set according to the present disclosure includes a plurality of ink jet ink compositions. In addition, at least one of the ink jet ink compositions constituting the ink jet ink composition set is the ink jet ink composition of the present disclosure described above.

At least one of the ink jet ink compositions constituting the ink jet ink composition set according to the present disclosure may be the ink jet ink composition of the present disclosure described above, and the ink jet ink composition set according to the present disclosure may include an ink jet ink composition not being the ink jet ink composition according to the present disclosure described above. In particular, the ink jet ink composition set according to the present disclosure preferably includes a plurality of ink jet ink compositions according to the present disclosure, and all the ink jet ink compositions constituting the ink jet ink composition set are more preferably the ink jet ink compositions of the present disclosure.

The ink jet ink composition set according to the present disclosure preferably includes three types of ink jet ink compositions corresponding to the three primary colors: cyan, magenta, and yellow. The three primary colors may be further subdivided according to color densities. For example, besides cyan, magenta, and yellow, light cyan, light magenta, and light yellow may be provided.

In addition, the ink jet ink composition set of the present disclosure may include an achromatic ink, more specifically, a black ink.

### 3. Recording Method

Next, a recording method of the present disclosure is described.

The recording method of the present disclosure includes ejecting and adhering the ink jet ink composition of the present disclosure to a recording medium by the ink jet method.

Therefore, the ink jet ink composition can be stably ejected, and the resultant recorded matter having excellent reliability can be stably provided.

### 3-1 Ejection

In ejection, the ink jet ink composition of the present disclosure is ejected as droplets by the ink jet method, and the droplets are adhered to the recording medium. Thus, a desired image is formed. An image may be formed by using a plurality of ink jet ink compositions, for examples, a plurality of ink jet ink compositions of the present disclosure.

The ink jet method for ejecting the ink jet ink composition may be any system, and examples thereof include a charge deflection system, a continuous system, a piezo system, an on-demand system such as a bubble jet (registered trade name) system, and the like.

### 4. Recorded Matter

A recorded matter according to the present disclosure is produced by using the ink jet ink composition of the present disclosure described above, and can be produced by using the recording method described above.

The preferred embodiments of the present disclosure are described above, but the present disclosure is not limited to these embodiments.

The recording medium to which the ink jet ink composition of the present disclosure is applied by the ink jet method may be any medium, but the recording medium may be, for example, paper such as plain paper or the like, paper exclusive for ink jet, a recording medium referred to as “coated paper” or the like, which is provided with an ink receiving layer, or the like, and it may be also a fabric.

### EXAMPLES

Next, examples of the present disclosure are described below.

### 5. Preparation of Ink Jet Ink Composition

### Example 1

The components shown in Table 1 were placed at a predetermined ratio in a predetermined vessel and then mixed and stirred by a stirrer for 2 hours. Then, the resultant mixture was filtered with a membrane filter having a pore diameter of 1 μm to prepare an ink jet ink composition having a composition shown in Table 1.

### Examples 2 to 14

Ink jet ink compositions were prepared by the same method as in Example 1 except that the types of the components used for preparing the ink jet ink compositions and the mixing ratio of each of the components were changed to provide the compositions shown in Table 1.

### Comparative Examples 1 to 4

Ink jet ink compositions were prepared by the same method as in Example 1 except that the types of the components used for preparing the ink jet ink compositions and the mixing ratio of each of the components were changed to provide the compositions shown in Table 1.

Table 1 summarizes the compositions of the ink jet ink compositions of the examples and the comparative examples. In the table, a mixture containing a black dye represented by formula (2) below and a black dye represented by formula (3) below at a mass ratio of 60:40 is denoted by “B-1”; a black dye represented by formula (4) below, “B-2”; a dye represented by formula (5) below, “B-3”; 1-(2-hydroxyethyl)-2-pyrrolidone, “HEP”; Surfynol MD-20 (manufactured by Air Products Japan Inc.) which is an acetylene glycol-based surfactant having a HLB value of 4, “SMD-20”; Surfynol 82 (manufactured by Air Products Japan Inc.) which is an acetylene glycol-based surfactant having a HLB value of 4, “S82”; Surfynol DF110D (manufactured by Air Products Japan Inc.) which is an acetylene glycol-based surfactant having a HLB value of 3, “SDF110D”; Surfynol SE (manufactured by Air Products Japan Inc.) which is an acetylene glycol-based surfactant having a HLB value of 6, “SSE”; Olfine 1010 (manufactured by Nissin Chemical Industry Co., Ltd) which is an acetylene glycol-based surfactant having a HLB value of 13, “E1010”; and trimethyl glycine, “TMG”. Table 1 also shows the value of XB/XA wherein XA [% by mass] is the content of the acetylene glycol-based surfactant having a HLB value of 4 or less in the ink jet ink composition, and XB [% by mass] is the content of 1-(2-hydroxyethyl)-2-pyrrolidone in the ink jet ink composition. In addition, the ink jet ink composition of any one of the examples had a value of surface tension at 25° C. within a range of 30 mN/m or more and 40 mN/m or less, and a value of viscosity at 25° C. within a range of 3 mPa·s or more and 8 mPa·s or less. The surface tension was measured by a Wilhelmy method using a surface tensiometer (DY-300, manufactured by Kyowa Interface Science Co., Ltd.), and the viscosity was measured according to JIS 28809 using a vibration-type viscometer (VM-100, manufactured by Sekonic Corporation).

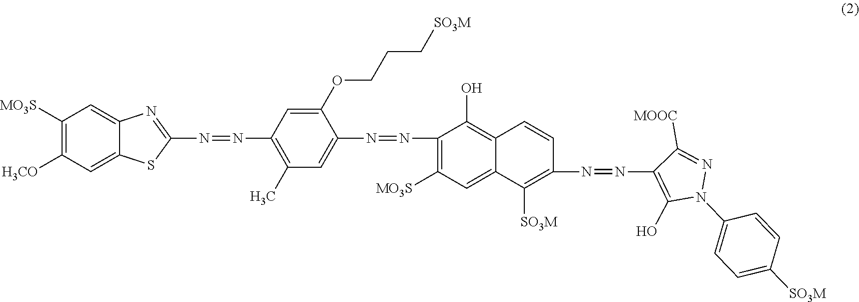

In the formula (2), M is Na.

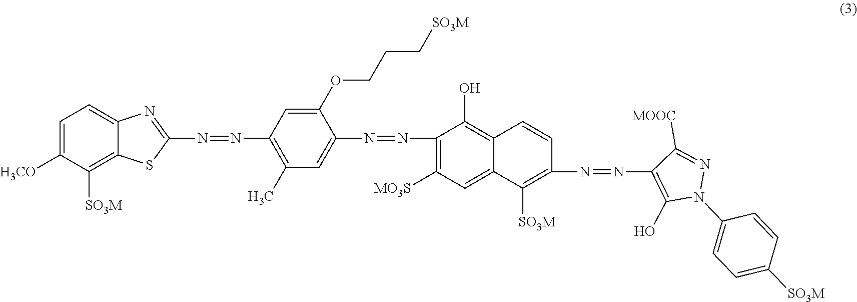

In the formula (3), M is Na.

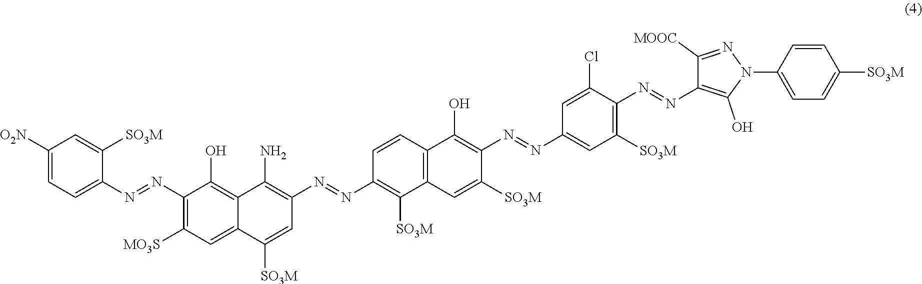

In the formula (4), M is Li.

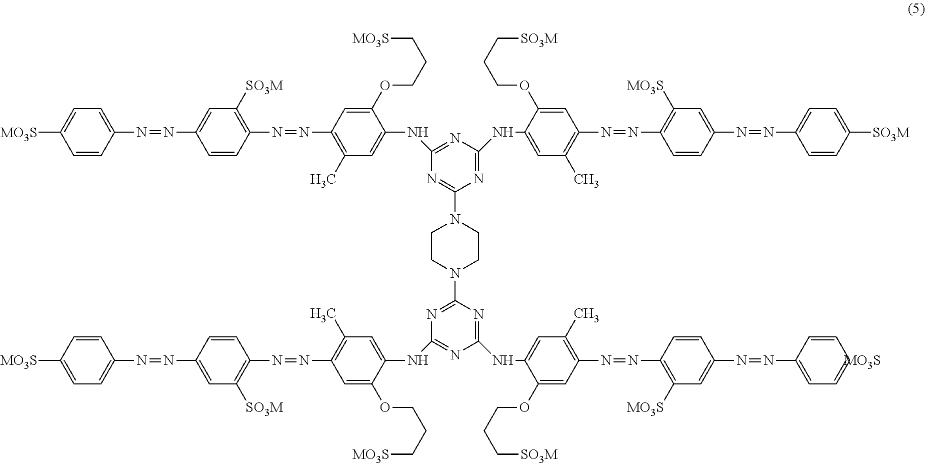

In the formula (5), M is Na.

TABLE 1

| | Content [% by mass] | | | | | | | | | | | |
|---|---|---|---|---|---|---|---|---|---|---|---|---|
| | | | | | | Surfactant | | | | | | |
| | | | | Water-soluble | | SMD-20 | S82 | SDF110D | SSE | E1010 | | |
| | Coloring material | | | organic solvent | | (HLB | (HLB | (HLB | (HLB | (HLB | | |
| | B-1 | B-2 | B-3 | HEP | TMG | value: 4) | value: 4) | value: 3) | value: 6) | value: 13) | Water | XB/XA |
| Example 1 | 2.00 | 2.00 | 1.00 | 2.00 | 3.00 | 0.10 | 0.00 | 0.00 | 0.00 | 0.50 | 89.40 | 20 |
| Example 2 | 2.00 | 2.00 | 1.00 | 2.00 | 3.00 | 0.05 | 0.00 | 0.00 | 0.00 | 0.50 | 89.45 | 40 |
| Example 3 | 2.00 | 2.00 | 1.00 | 5.00 | 3.00 | 1.00 | 0.00 | 0.00 | 0.00 | 0.50 | 85.50 | 5 |
| Example 4 | 2.00 | 2.00 | 1.00 | 0.50 | 3.00 | 0.10 | 0.00 | 0.00 | 0.00 | 0.50 | 90.90 | 5 |
| Example 5 | 2.00 | 2.00 | 1.00 | 5.00 | 3.00 | 0.10 | 0.00 | 0.00 | 0.00 | 0.50 | 86.40 | 50 |
| Example 6 | 2.00 | 2.00 | 1.00 | 2.00 | 3.00 | 0.05 | 0.00 | 0.00 | 0.00 | 0.00 | 89.95 | 40 |
| Example 7 | 2.00 | 2.00 | 1.00 | 2.00 | 0.50 | 0.10 | 0.00 | 0.00 | 0.00 | 0.50 | 91.90 | 20 |
| Example 8 | 2.00 | 2.00 | 1.00 | 2.00 | 5.00 | 0.10 | 0.00 | 0.00 | 0.00 | 0.50 | 87.40 | 20 |
| Example 9 | 2.00 | 2.00 | 1.00 | 2.00 | 0.00 | 0.10 | 0.00 | 0.00 | 0.00 | 0.50 | 92.40 | 20 |
| Example 10 | 0.20 | 0.20 | 0.10 | 1.00 | 0.00 | 0.10 | 0.00 | 0.00 | 0.00 | 0.50 | 97.90 | 10 |
| Example 11 | 2.20 | 2.20 | 1.10 | 3.00 | 3.00 | 0.10 | 0.00 | 0.00 | 0.00 | 0.50 | 87.90 | 30 |
| Example 12 | 2.00 | 2.00 | 1.00 | 5.00 | 3.00 | 0.05 | 0.00 | 0.00 | 0.00 | 0.50 | 86.45 | 100 |
| Example 13 | 2.00 | 2.00 | 1.00 | 2.00 | 3.00 | 0.00 | 0.10 | 0.00 | 0.00 | 0.50 | 89.40 | 20 |
| Example 14 | 2.00 | 2.00 | 1.00 | 2.00 | 3.00 | 0.00 | 0.00 | 0.10 | 0.00 | 0.50 | 89.40 | 20 |
| Comparative | 2.00 | 2.00 | 1.00 | 0.00 | 3.00 | 0.10 | 0.00 | 0.00 | 0.00 | 0.50 | 91.40 | 0 |
| Example 1 | | | | | | | | | | | | |
| Comparative | 2.00 | 2.00 | 1.00 | 0.00 | 3.00 | 0.00 | 0.00 | 0.00 | 0.00 | 0.50 | 91.50 | 0 |
| Example 2 | | | | | | | | | | | | |
| Comparative | 2.00 | 2.00 | 1.00 | 0.00 | 3.00 | 0.00 | 0.00 | 0.00 | 0.10 | 0.50 | 91.40 | 0 |
| Example 3 | | | | | | | | | | | | |
| Comparative | 2.00 | 2.00 | 1.00 | 0.50 | 3.00 | 0.00 | 0.00 | 0.00 | 0.00 | 0.50 | 91.00 | 0 |
| Example 4 | | | | | | | | | | | | |

### 6. Evaluation

The ink jet ink composition of each of the examples and the comparative examples was evaluated as follows.

### 6-1 High-Temperature Stability (Turbidity Evaluation)

A solution was prepared so as to provide a composition in which the coloring material was removed from the ink jet ink composition of each of the examples and the comparative examples, and it was visually confirmed that turbidity was not present in the resultant solution. Next, a predetermined amount of the ink jet ink composition of each of the examples and comparative examples was placed in each of two bottles, one of the bottles being allowed to stand in an environment of 60° C. for 24 hours, the other being allowed to stand in an environment of 70° C. for 24 hours. After being allowed to stand, the occurrence conditions of turbidity in each of the solutions was confirmed and evaluated according to criteria below. The evaluation “B” or better was considered as a good level.

A: No turbidity occurs even at both 60° C. and 70° C.
B: Turbidity/separation occurs at 70° C., but no turbidity occurs at 60° C.
C: Turbidity/separation occurs at both 60° C. and 70° C.

### 6-2 Clogging Recoverability

First, a cartridge for ink jet printer EP-10VA (manufactured by Seiko Epson Corporation) was filled with a predetermined amount of the ink jet ink composition of each of the examples and the comparative examples.

Then, a cleaning operation was performed for the ink jet printer provided with the cartridge, and the flow passage of the ink jet printer was filled with the ink jet ink composition and then allowed to stand in an environment of 40° C./25% RH for 1 week in a state where the head was not returned to the home position, that is, in a state where a head cap was not put on the head nozzle surface.

Then, a nozzle check pattern was printed, and the recoverability of clogging with the ink jet ink composition in the ink jet head was evaluated by observing the ejection conditions of nozzles according to criteria below. The result “B” or better was considered as a good level.

S: The ink jet ink composition is normally ejected from all nozzles with one cleaning operation.
A: The ink jet ink composition is normally ejected from all nozzles with two or three cleaning operations.
B: The ink jet ink composition is normally ejected from all nozzles with four or five cleaning operations.
C: Six or more cleaning operations are required until the ink jet ink composition is normally ejected from all nozzles, or the ink jet ink composition is not normally ejection from some of the nozzles even with six or more cleaning operations.

### 6-3 Defoaming Property

First, 20 mL of the ink jet ink composition of each of the examples and the comparative examples was filled in a 100 mL glass bottle, and then shaken up and down 10 times. Then, the time to disappearance of the produced foam was measured and evaluated according to criteria below. It was considered that the shorter the time to disappearance of the produced foam is, the more excellent the defoaming property is. The result “B” or better is considered as a good level.

A: The time to disappearance of the produced foam is less than 3 minutes.
B: The time to disappearance of the produced foam is 3 minutes or more and less than 10 minutes.
C: The time to disappearance of the produced foam is 10 minutes or more.

### 6-4 Initial Filling Property

First, a cartridge for ink jet printer PX-G930 (manufactured by Seiko Epson Corporation) was filled with the ink jet ink composition of each of the examples and the comparative examples. Then, nozzle check was performed to evaluate according to criteria below. The result “B” or better was considered as a good level.

A: No omission occurs in the nozzle check after initial filling.
B: Omission occurs in the nozzle check after initial filling, but is completely recovered by one time of head cleaning.
C: Omission occurs in the nozzle check after initial filling and is not completely recovered even by one time of head cleaning.

These results are shown in Table 2.

TABLE 2

| | High-temperature | Clogging | Defoaming | Initial filling |
|---|---|---|---|---|
| | stability | recoverability | property | property |
| Example 1 | A | A | B | A |
| Example 2 | A | A | B | A |
| Example 3 | B | S | A | A |
| Example 4 | A | B | B | A |
| Example 5 | A | S | B | A |
| Example 6 | A | A | B | B |
| Example 7 | A | A | B | A |
| Example 8 | A | A | B | A |
| Example 9 | A | A | B | A |
| Example 10 | A | A | B | A |
| Example 11 | A | B | B | A |
| Example 12 | A | S | B | A |
| Example 13 | A | A | B | A |
| Example 14 | A | A | B | A |
| Comparative | C | C | B | A |
| Example 1 | | | | |
| Comparative | C | C | C | C |
| Example 2 | | | | |
| Comparative | C | C | C | B |
| Example 3 | | | | |
| Comparative | B | B | C | C |
| Example 4 | | | | |

Table 2 indicates that the present disclosure produces the excellent results. On the other hand, the comparative examples do not produce satisfactory results.

What is claimed is:

1. An ink jet ink composition comprising:
a coloring material;
water;
an acetylene glycol-based surfactant having a HLB value of 4 or less; and
1-(2-hydroxyethyl)-2-pyrrolidone.

2. The ink jet ink composition according to claim 1,
wherein the content of the acetylene glycol-based surfactant having a HLB value of 4 or less in the ink jet ink composition is 0.05% by mass or more and 1.0% by mass or less.

3. The ink jet ink composition according to claim 1,
wherein the content of the 1-(2-hydroxyethyl)-2-pyrrolidone in the ink jet ink composition is 0.5% by mass or more and 5.0% by mass or less.

4. The ink jet ink composition according to claim 1, further comprising a surfactant having a HLB value of 10 or more.

5. The ink jet ink composition according to claim 1, further comprising trimethyl glycine at a content of 5.0% by mass or less.

6. The ink jet ink composition according to claim 1, wherein the coloring material is a dye.

7. The ink jet ink composition according to claim 1,
wherein the content of the coloring material in the ink jet ink composition is 1.0% by mass or more and 5.5% by mass or less.

8. The ink jet ink composition according to claim 1,
wherein when the content of the acetylene glycol-based surfactant in the ink jet ink composition is XA [% by mass], and the content of the 1-(2-hydroxyethyl)-2-pyrrolidone in the ink jet ink composition is XB [% by mass], a relation of the following formula (1) is satisfied.
5≤XB/XA≤100 (1)

9. A recording method comprising ejecting and adhering the ink jet ink composition according to claim 1 to a recording medium by an ink jet method.
